(19) United States
(12) Patent Application Publication
(10) Pub. No.: US 2005/0234827 A1
(43) Pub. Date: Oct. 20, 2005

(54) System for processing executable applications to be suitable for distribution

(76) Inventor: Michael J. Rudowsky, Exton, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/090,887

(22) Filed: Mar. 25, 2005

Related U.S. Application Data
(60) Provisional application No. 60/562,004, filed on Apr. 14, 2004.

(51) Int. Cl. G06F 17/60

(52) U.S. Cl. 705/51

(57) ABSTRACT

A system for processing executable applications to be suitable for distribution includes a repository of data files representing a plurality of different executable applications available for distribution and a repository of ancillary information associated with processing selected executable applications for distribution. The ancillary information identifies characteristics determining aspects of installation of selected executable applications at a user site. A packaging processor collates selected executable applications and associated ancillary information to provide distribution data. A storage processor generates a distribution package comprising the distribution data and stores a copy of the distribution data in a database. A distribution processor processes the distribution package to be suitable for distribution.

### CROSS-REFERENCE TO RELATED APPLICATIONS

The present application is a non-provisional application of provisional application having Ser. No. 60/562,004 filed by Michael J. Rudowsky, Apr. 14, 2004.

### FIELD OF THE INVENTION

The present invention relates to distributing executable applications to user sites, and more particularly to a system for automatically packaging an executable application in a form suitable for distribution to a user site and installing the application at the user site in response to an order from the user site.

### BACKGROUND OF THE INVENTION

The final step in the development of executable applications is to distribute these executable applications to a user site. For relatively simple executable applications, which either do not interact with other executable applications, or whose interactions are relatively simple, a single, a generally applicable distribution package, containing the data required to properly install the executable application on a user site, may be generated and distributed. Such a distribution package may be distributed on a physical portable medium, through file transfer, or directly to the user site via an electronic network such as the internet.

However, relatively complex executable applications may require a high degree of integration with other executable applications at the user site. Such integration may be very tight, including: (a) coordination of commonly used data; and (b) coordinated timing of execution of multiple executable applications. For these reasons, such complex executable applications are distributed in packages which are tailored to the specific user site at which the executable application is to be installed.

Manufacturers of such relatively more complex executable applications currently receive orders for executable applications from user sites. These orders are tracked to ensure that the user site satisfies the sales criteria for placing an order, e.g. pays for the ordered executable applications, and that the ordered executable application is provided to the user site in a timely manner. In general, a sales group maintains information related to a user site and information related to orders received from a user site. This information is sent to a distribution group when the ordering procedures (payment received, etc.) have been satisfied. In general, this information is sent in a message from the sales group to the distribution group, such as in an e-mail message or paper memorandum. This message includes user site related information and order related information.

The distribution group transcribes the user site and order related information into its own database. The distribution group database may include further information related to the configuration of the processor at the user site, such as the type and capacity of the processor and the executable applications already installed. This is especially important when the distribution package needs to be tailored to install and operate properly at this user site, as described above. The distribution group generates a distribution package, containing the ordered executable application in a form appropriate for the user site. When the distribution package is generated, it is transferred to a distribution medium. In current systems, this is a physical portable distribution medium, such as a CD. This distribution medium, e.g. CD, is sent to the user site, where the executable application may be installed on the user site.

When the distribution medium has been sent to the user site, the distribution group sends a message to the sales group. This message includes user site related information, order related information, and information related to the distribution package and the delivery of the package to the user site. The sales group updates its database with this information.

The current system requires manual transcription of user site, order, and distribution related data between the sales group and the distribution group. Manual transcription, however, has a relatively large potential for introducing errors. For example, numbers may be transposed and text may be mistyped. Manual transcription is also a relatively slow process, which increases the time necessary to receive, process, begin work on, and fulfill an order. Further, manual transcription requires human intervention, which increases the cost for order processing at both the sales group and the distribution group. The current system also uses physical portable distribution media and does not use electronic network distribution for distribution packages. This increases the cost of distribution and does not take advantage of the speed of electronic network distribution. Further, because the user database in the sales group is separate from the database in the distribution group, auditing and order tracking is slow, error prone and costly.

A system is desired which addresses the deficiencies found in the current system, described above, regarding customer tracking and auditing, reporting, labor-intensive data entry, and a lack of potential for use of electronic distribution function. In addition, a system is desired which integrates seamlessly with customer order management in order to minimize manual processes that introduce errors and to expedite delivery of software.

### BRIEF SUMMARY OF THE INVENTION

In accordance with principles of the present invention, a system for processing executable applications to be suitable for distribution includes a repository of data files representing a plurality of different executable applications available for distribution and a repository of ancillary information associated with processing selected executable applications for distribution. The ancillary information identifies characteristics determining aspects of installation of selected executable applications at a user site. A packaging processor collates selected executable applications and associated ancillary information to provide distribution data. A storage processor generates a distribution package comprising the distribution data and stores a copy of the distribution data in a database. A distribution processor processes the distribution package to be suitable for distribution.

### BRIEF DESCRIPTION OF THE DRAWING

In the drawing:

FIG. 1 is a block diagram of a system for processing executable applications to be suitable for distribution; and

FIG. 2 is a more detailed block diagram of the system illustrated in FIG. 1.

### DETAILED DESCRIPTION OF THE INVENTION

As used herein, a processor operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprise any combination of, hardware, firmware, and/or software. A user interface comprises one or more display images, generated by the display processor under the control of the processor, enabling user interaction with a processor or other device.

An executable application as used herein comprises code or machine readable instructions for conditioning the processor to implement predetermined functions, such as those of an operating system, healthcare information system or other information processing system, for example, in response user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

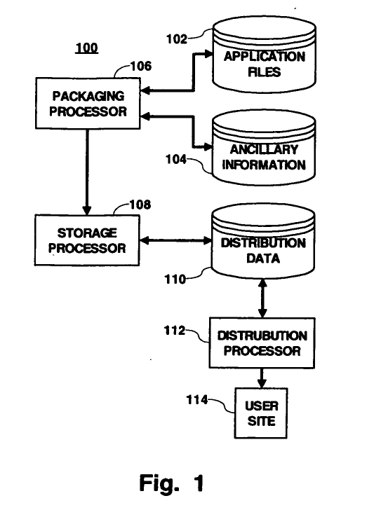

FIG. 1 is a block diagram of a system 100 for processing executable applications to be suitable for distribution. In FIG. 1, a storage device 102 stores data files representing one or more executable applications. The application file storage device 102 is coupled to a packaging processor 106. A storage device 104 stores ancillary information associated with processing the executable applications for distribution. The ancillary information storage device 104 is also coupled to the packaging processor 106. The packaging processor 106 is coupled to a storage processor 108. The storage processor 108 is coupled to a storage device 110 for containing a database storing a copy of distribution data. The distribution data storage device 110 is coupled to a distribution processor 112. The distribution processor 112 is coupled to a user site 114.

In operation, a programmer or programming team (not illustrated) generates a data file or set of data files representing an executable application using software development tools. The programmer saves these files in the application file storage device 102. These data files may include: (a) executable files, which are data files containing executable applications or procedures; (b) parameter files, which are data files containing parameters or sets of parameters required by the executable application or procedures; and/or (c) library files, which are data files containing one or more sets of parameters and/or executable procedures for providing generally required parameters and/or functions required by the executable application or other executable procedures. One skilled in the art understands that other types of data files, containing other types of data, such as source code files, object code files, linking data files, and so forth, supporting the development and execution of the executable application, may be generated by the programmer or programming team, and may also stored in the application file storage device 102. In addition, in general, more than one executable application is being generated or maintained. Thus, the application file storage device 102 operates as a repository of data files representing a plurality of different executable applications available for distribution.

The programmer or programming team also generates ancillary data, sometimes termed metadata, associated with the executable applications. The ancillary information is stored in the ancillary information storage device 104. This ancillary information is not required by the executable application during its operation. Instead, it includes data describing the executable application. For example, some of the ancillary information may include data associated with processing selected executable applications for distribution, i.e. information identifying characteristics determining aspects of installation of a selected one or more executable applications at a user site. Similarly to the application file storage device 102, in general the ancillary storage device operates as a repository of ancillary information associated with one or more executable applications.

More specifically, in the illustrated embodiment, the ancillary information may include data necessary to properly install the selected executable applications at the user site. This information may include, for example, (a) the names of the selected executable applications, (b) the relationship of the selected executable applications with other executable applications that are to be delivered with the processed distribution data, and/or (c) information concerning system characteristics required to enable successful installation. The information concerning system characteristics required to enable successful installation may include, for example, (a) an installed directory structure for containing the selected executable applications, (b) characteristics of files containing the selected executable applications, and/or (c) registration information required for enabling installation.

The ancillary information may also disclose the development status of the associated executable application. For example, the programmer or programming team may indicate that an executable application, having files stored in the application file storage device 102, is: (a) available for distribution; (b) under current development and, thus, unavailable for distribution; (c) has updates available for distribution to user sites on which this executable application is installed and/or (d) has been withdrawn. The reason for withdrawal may also be indicated, for example (a) for business reasons or due to business requirements; and/or (b) because of regulatory requirements. Ancillary information indicating this may be stored in the ancillary information storage device 104.

The ancillary information may be stored in the ancillary information storage device 104 in the form of a relational database maintained under the control of the packaging processor 106. In such a case, the packaging processor 106 may be implemented as a database management system (DBMS). Use of a relational database to store this data permits tighter integration with the programmer team tools and easier report generation, as discussed below. In addition, use of a relational database permits easier integration with other enterprise systems, such as customer order management systems.

The packaging processor 106 interacts with the programmer or programming team via a user interface to control the solicitation and reception of ancillary information related to application data files. More specifically, in the illustrated embodiment, the packaging processor 106 includes a user interface which may implement version control, freezing and unfreezing of such packages, marking packages as under development, available for distribution, or obsolete, and so forth. The packaging processor 106 user interface may also solicit from the programmer or programming team the ancillary information, described above, necessary for proper installation of the selected application files at the user site: i.e. names of the selected executable applications, the relationship of the selected executable applications with other executable applications that are to be delivered with the processed distribution data, and information concerning system characteristics required to enable successful installation such as an installed directory structure for containing the selected executable applications, characteristics of files containing the selected executable applications, and registration information required for enabling installation, and so forth. The packaging processor 106 controls the storage of that ancillary information in appropriate tables, records, and fields in the relational database in ancillary information storage device 104.

An order, including information selecting one or more desired executable applications, may be received from a user site 114. In response, the packaging processor 106 collates the selected executable applications and associated ancillary information to provide distribution data. The order from the user may be received by any means, such as by mail, by phone, or by electronic means such as e-mail or a world-wide-web site request. In response to the receipt of an order from a user site 114, e.g. an electronic order, the packaging processor 106 automatically selects the desired executable applications in the application file storage device 102 and collates the selected executable applications and associated ancillary information to provide the distribution data.

The distribution data specifies the selected application data files in the application data storage device 102 and associated ancillary information in the ancillary information storage device 104 necessary to properly install these data files at the user site 114. The storage processor 108 processes the distribution data to generate a distribution package including the distribution data, in a manner described in more detail below, and stores a copy of the resulting distribution package in the distribution data storage device 110. In a similar manner, to the ancillary information in the ancillary information storage device 104, the distribution package may be stored in a relational database on the distribution data storage device 110.

The ancillary information may also include information representing the identity of the user site 114 which ordered the distribution package and other order related information. The user identification information and other order related information may also be stored with the distribution package in the database on the distribution data storage device 110. Storage of this information facilitates order tracking. The storage processor 108 may also maintain a log of accesses to: (a) the stored user identification information; (b) the stored order related information; and/or (c) the stored distribution package. The access log permits maintenance of an audit trail indicating access to the stored information.

The storage processor 108 processes the received distribution data to produce a media image of the distribution package capable of being sent to the user site 114. The storage processor 108 automatically links the associated ancillary information with corresponding selected executable applications, based on predetermined mapping information to provide the media image. This media image may contain one or more installation files containing the application data files and installation instructions. Many methods exist for preparing executable applications for installation at user sites. For example, Microsoft Corporation supports an installation protocol, and a tool for generating installation packages, for such installations. InstallShield by Macrovision Corporation supports another installation protocol, and a tool for generating installation packages, for such installations. Other such protocols and tools exist.

In the illustrated embodiment, InstallShield is the selected to be the standard install process for generating distribution packages, for example. The storage processor 108 invokes the InstallShield distribution package generator tool and provides it with instructions based on the ancillary information related to the installation of the selected executable applications at the user site 114. In the case of InstallShield, a single file, incorporating the required files, is generated. This file is, itself an executable file including an executable application which controls the installation of the selected executable applications. The InstallShield executable application may automatically generate the required directory structure, automatically extract the executable application files and store them in appropriate locations on the processor at the user site 114. The InstallShield executable application may also automatically perform any registration functions required. The InstallShield executable application also includes a user interface which may solicit information from a user necessary to properly install the selected executable applications.

The InstallShield installation file may be accompanied by other files, such as ‘Read-me’ files giving last minute information concerning the selected executable application, licensing files setting out details of the license under which the selected executable applications are being distributed, help files for performing the installation process, and so forth. These files are formed into a media image. This media image is stored in the distribution data storage device 110.

The distribution processor 112 retrieves distribution packages from the distribution data storage device 110 and processes those packages to be suitable for distribution. For example, the media image of the distribution package may be stored on a physical distribution media. The distribution processor 112 also automates tasks necessary to create labels for the physical distribution medium. The distribution medium provides the distribution package to the user site 114. At the user site, the InstallShield executable application may be executed to install the selected executable applications.

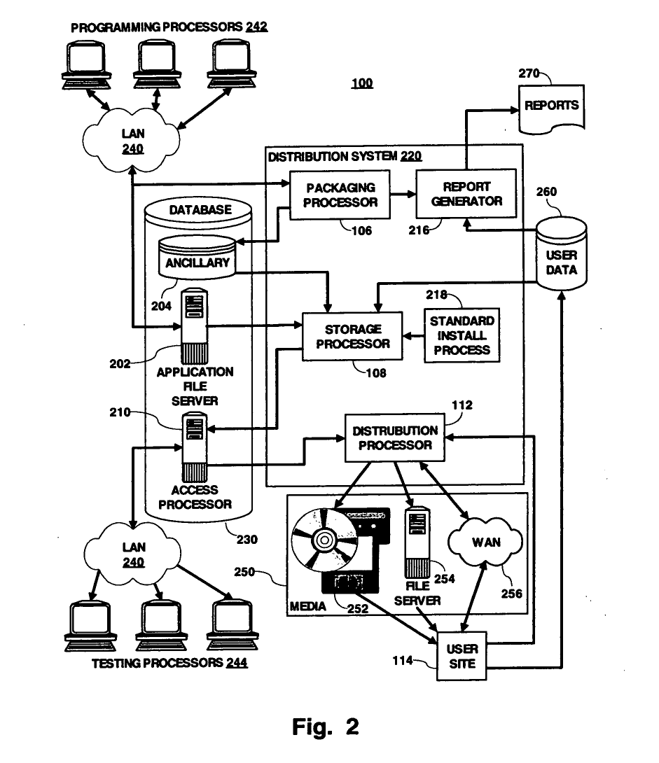

FIG. 2 is a more detailed block diagram of the system 100 illustrated in FIG. 1. In FIG. 2, those elements which are the same as those illustrated in FIG. 1 are designated by the same reference number and are not described in detail below. In FIG. 2, a programming team is represented by a plurality of programming processors 242 bidirectionally coupled to a LAN 240. The LAN 240 is bidirectionally coupled to an application file server 202 and the packaging processor 106. An output terminal of the packaging processor 106 is coupled to an ancillary information database 204. The application file server 202 and the ancillary information database 204 are coupled to respective input terminals of the storage processor 108. A standard install process 218 is also coupled to the storage processor 108. The standard install process 218 provides the instructions for generating a distribution package. For example, the standard install process 218 may include the tool provided by InstallShield.

An output terminal of the storage processor 108 is coupled to an input terminal of an access processor 210. An output terminal of the access processor 210 is coupled to an input terminal of a distribution processor 112. The access processor 210 is also bidirectionally coupled to the LAN 240. (In FIG. 2, the LAN 240 is illustrated as two separate clouds in order to simplify the figure. One skilled in the art understands that the LAN 240 interconnects the processors coupled to it and is not intended to be two separate networks.) A testing team is represented by a plurality of testing processors 244 bidirectionally coupled to the LAN 240. The ancillary information database 204, the application file server 202 and the access processor 210, in combination, form a distribution system database 230. This database is stored in the form of a relational database, as described above, and is distributed among different file servers, as illustrated in FIG. 2.

The distribution processor 112 is coupled to the user site 114 via distribution media 250. In FIG. 2, these media 250 are illustrated as physical media 252 (magnetic tape, floppy disk, CD and/or DVD), a file server 254, and a wide area network (WAN) 256. The user site 114 also has an output terminal coupled to an input terminal of the distribution processor. The system 100 further includes a user data database 260. The user site 114 is coupled to the user data database 260. Respective output terminals of the user data database 260 are coupled to the storage processor 108 and a report generator 216. An output terminal of the packaging processor 106 is coupled to a second input terminal of the report generator 216. The report generator 216 is coupled to a means 270 for generating reports. The packaging processor 106, storage processor 108, distribution processor 112, standard install process 218 and report generator 216, in combination, form a distribution system 220.

The operation of the distribution system 100 illustrated in FIG. 2 is similar to that described above with respect to FIG. 1. The programming team, using the programming processors 242, generates, edits, and stores, via the LAN 240, application data files representing executable applications on the application file server 202. The application file server 202 includes (though it is not shown) an application file storage device 102 (FIG. 1) in which the application data files are stored. The user interface of the packaging processor 106 interacts, via the LAN 240, with the programming team at the programming processors 242 to solicit ancillary information. The ancillary information is stored in the ancillary information database 204. The ancillary information database 204 includes (though it is not shown) an ancillary information storage device 104 (FIG. 1) in which the ancillary information is stored. The storage processor 108 collates application files from the application file server 202 with associated ancillary information from the ancillary information database 204 to generate distribution packages. The distribution packages are stored in the access processor 210 in the form of media images. The access processor 210 includes (though it is not shown) a distribution data storage device 110 (FIG. 1) in which the distribution packages are stored. The distribution packages are processed by the distribution processor 112 to generate distribution media 250 which may be supplied to the user site 114, as described in detail above.

The user site 114 may desire a specific distribution medium. The user site 114 may send a command to the distribution processor 112 including data representing the selected medium. Alternatively, the user site 114 may send a command to the user database 260 containing the desired distribution medium for that user site. That selection is stored in the user database 260 along with other user information. The storage processor 108 retrieves the desired medium from the user database 260 when preparing the distribution package and includes data representing that selection with the distribution package in the access processor 210. The distribution processor 112, in that case, retrieves the selection data when it retrieves the distribution package from the access processor 210. In either case, the distribution processor 112 uses the selected distribution medium when processing the distribution package to be suitable for distribution.

For example, a user site 114 may specify that the distribution package be stored on a portable storage medium 252 such as a magnetic tape, a floppy disc, a compact disc (CD), a digital versatile disc (DVD), etc. In this case, the distribution processor 112 may incorporate the distribution package into the selected portable storage medium 252, sometimes termed burning the media image. The portable storage medium 252, e.g. magnetic tape, floppy disc, CD or DVD, may be sent to the user site 114. At the user site 114, the distribution medium 252 may be read by a corresponding media reader on the user processing system and the selected executable applications installed by executing the InstallShield executable application on the distribution medium.

The user site 114 may also request that the distribution package be made available for file transfer. In this case, the distribution processor 112 transfers the distribution package to a file server 254, which is accessible by the user site 114. The file server 254 may be collocated at the system 100 site; may be at a different location; or outsourced to a different company. The user site 114 accesses the file server 254 and requests the desired distribution package. The file server 254 transfers the requested distribution package to the user site 114 via any of a plurality of known methods such as the file transfer protocol (FTP). At the user site 114, the selected executable applications may be installed by executing the InstallShield executable application in the received distribution package.

Alternatively, the user site 114 may request that the distribution package made available for electronic network distribution. The distribution processor 112 may be coupled to the user site 114 via a wide area network (WAN) 256 such as the internet. In this arrangement, the distribution processor 112 operates as a distribution server: receiving requests via the WAN 256 from the user site 114 for a distribution package; retrieving the appropriate distribution package from the access processor 210; and sending the distribution package via the WAN 256 to the requesting user site 114 in response. At the user site 114, the selected executable applications may be installed by executing the InstallShield executable application in the received distribution package.

The use of an access processor 210 to store distribution packages advantageously makes it unnecessary to recreate the distribution package each time it is requested. This reduces the time necessary to create distribution media in response to a request from the user site 114. If electronic network distribution via a WAN 256 is the selected distribution medium, then no processing is required at all, because the file already in the access processor 210 is sent to the user site 114 via the WAN 256.

In addition, coupling the access processor 210 to the LAN 240, provides a centralized access to the stored copies of the distribution packages. This allows other entities within the system 100 to access the distribution packages. For example, for quality control purposes distribution package may be tested before being released for distribution to user sites 114. Testers, represented by the testing processors 244 may access distribution packages in the access processor 210 for testing. By providing access to the access processor 210, no distribution media, e.g. portable storage media such as magnetic tape, floppy discs, CDs, DVDs etc. need to be burned. This advantageously reduces the time and cost necessary to test distribution packages.

The user database 260 is external to the distribution system 220 and may be an order management system (OMS) or customer relationship management system (CRM). The user database 260 may be an externally developed database program or a database developed within the system 100. In either case, it maintains data representing user sites, and is made available to the distribution system 220. Integration of the user database 260 with the distribution system 220 permits automatic tracking of received orders from user sites 114 and of transfer of the ordered distribution packages to the user sites 114. This integration also permits automatic transfer of user site information to the storage processor 108, which generates the desired distribution package. This, in turn, minimizes clerical errors which may occur when data is manually transferred from an OMS to a prior art distribution system.

The report generator 216 has access to information from both the user database 260 and the distribution system database 230 via the packaging processor 106. Because both the user database 260 and the distribution system database 230 are in the form of relational databases, information may be easily extracted and formatted for generating desired reports 270. Any of a plurality of known report generation executable applications, such as Crystal Reports (by Crystal Decisions), XL Report Builder (by Desktop Software), etc., may be used to format desired reports and to produce those reports on the report generating means 270 on request. Reports may be generated which provide information from the software manufacturer point of view or from a user site 114 point of view.

From the manufacturer point of view, reports may include, for example: lists of executable applications under development (the report including (a) upcoming executable application releases, and/or (b) expected date of availability of an executable application); lists of executable applications ready to be packaged for distribution; lists of distribution packages available (in the access processor 210) for distribution; audit trail reports listing accesses to the distribution packages in the access processor 210 (described above); lists of user sites 114 which have received a distribution package; lists of distribution packages sent to a particular user site 114; etc.

From the point of view of the user site 114, reports, in general, include information identifying the user site 114 and information related to one or more orders made by that user site 114. Such reports may include: lists of distribution packages sent to that user site 114; lists of distribution packages ordered but not yet delivered; a list of executable applications installed at the user site 114 along with a list of executable applications which are available for distribution but not installed (i.e. information enabling a user to compare what is installed at a user site with what is available in the distribution system database 230 to enable a user to identify applications not installed), etc.

A distribution system as illustrated in FIG. 1 and FIG. 2 and described above enables automatic tracking and auditing of distribution packages ordered by user sites. Automatic use of order related information, received from user sites and stored in the user database, eliminates manual transcription of such data. This eliminates the potential for introducing errors into order information resulting from manual transcription. It also reduces the time for processing orders, and thus reduces the costs. This also minimizes time between an order being received from a user site and delivery of a distribution medium containing the ordered executable application. Such a system also permits electronic network distribution of distribution packages, eliminating the costs and time involved in producing distribution packages on physical portable distribution media.

1. A system for processing executable applications to be suitable for distribution, comprising:
a repository of data files representing a plurality of different executable applications available for distribution;
a repository of ancillary information associated with processing selected executable applications for distribution, said ancillary information identifying characteristics determining aspects of installation of a selected one or more executable applications at a user site;
a packaging processor for collating selected executable applications and associated ancillary information to provide distribution data;
a storage processor for generating a distribution package comprising the distribution data and storing a copy of said distribution package in a database; and
a distribution processor for processing said distribution package to be suitable for distribution.

2. A system according to claim 1, wherein said ancillary information is stored in the ancillary information repository in the form of a relational database.

3. A system according to claim 1, wherein said ancillary information, identifying characteristics determining aspects of installation of selected executable applications at a user site, comprises at least one of: (a) an installed directory structure for containing said selected executable applications, (b) characteristics of files containing said selected executable applications, and (c) registration information required for enabling installation.

4. A system according to claim 1, wherein said ancillary information, identifying characteristics determining aspects of installation of selected executable applications at a user site, comprises at least one of: (a) names of said selected executable applications, (b) relationship of said selected executable applications with other executable applications that are to be delivered with said processed distribution data, and (c) information concerning system characteristics required to enable successful installation.

5. A system according to claim 4, wherein said information concerning system characteristics required to enable successful installation comprises at least one of: (a) an installed directory structure for containing said selected executable applications, (b) characteristics of files containing said selected executable applications, and (c) registration information required for enabling installation.

6. A system according to claim 1, wherein said packaging processor allows a user to indicate the status of an executable application as at least one of: (a) available, (b) under development, and (c) having updates available.

7. A system according to claim 1, wherein said packaging processor removes executable applications from said database in response to at least one of: (a) business requirements, and (b) regulatory requirements.

8. A system according to claim 1, wherein said packaging processor automatically selects said selected executable applications in response to received electronic order information initiated by a user.

9. A system according to claim 1, wherein said packaging processor collates said selected executable applications and associated ancillary information in response to received electronic order information initiated by a user.

10. A system according to claim 1, wherein said storage processor automatically links said associated ancillary information with corresponding selected executable applications based on predetermined mapping information to provide a media image.

11. A system according to claim 1, wherein said storage processor automatically stores user identification information and order related information together with said stored copy of said distribution package to support order tracking.

12. A system according to claim 11, wherein said storage processor automatically stores information identifying access to at least one of, (a) stored user identification information, (b) stored order related information and (c) stored distribution package, to maintain an audit trail indicating access to stored information.

13. A system according to claim 1, wherein said distribution processor processes said distribution package to be suitable for distribution in a medium, selected in response to user command from at least one of: (a) a portable storage medium, (b) electronic network distribution, and (c) file transfer.

14. A system according to claim 1, further comprising an access processor providing centralized access to said stored copy of said distribution package.

15. A system according to claim 1, further comprising a testing processor coupled to said access processor to provide access to said stored copy of said distribution data to support testing of said distribution package.

16. A system according to claim 1, further comprising a report generator for generating a report including user identification information and order related information.

17. A system according to claim 1, further comprising a report generator for generating a report including information identifying at least one of: (a) upcoming executable application releases, and (b) expected date of availability of an executable application.

18. A system according to claim 1, further comprising a report generator for generating a report including information enabling a user to compare what is installed at a user site with what is available in said database to enable a user to identify applications not installed.
